(19) United States
(12) Patent Application Publication
(10) Pub. No.: US 2019/0098915 A1
(43) Pub. Date: Apr. 4, 2019

(54) NUTRIENT-SPORE FORMULATIONS AND USES THEREOF

(71) Applicant: NCH Life Sciences LLC, Irving, TX (US)

(72) Inventors: JORDAN E. CHURCH, Irving, TX (US); GABRIEL F. K. EVERETT, Irving, TX (US); CHARLES J. GREENWALD, Irving, TX (US); JUDITH G. PRUITT, Irving, TX (US); SKYLAR R. WHITE, Irving, TX (US)

(21) Appl. No.: 16/151,805

(22) Filed: Oct. 4, 2018

Related U.S. Application Data
(60) Provisional application No. 62/567,974, filed on Oct. 4, 2017.

(51) Int. Cl. A23K 10/18; A23K 50/75; A23K 50/80; A01N 63/00

(52) U.S. Cl. CPC A23K 10/18; A01N 63/00; A23K 50/80; A23K 50/75

(57) ABSTRACT

Described herein are nutrient formulations, spore formulations, and nutrient-spore formulations. Also described herein are methods of making and using the nutrient formulations, spore formulations, and nutrient-spore formulations.

### CROSS-REFERENCE TO RELATED APPLICATIONS

This application claims the benefit of and priority to co-pending U.S. Provisional Patent Application No. 62/567,974, filed on Oct. 4, 2017, entitled “NUTRIENT-SPORE FORMULATIONS AND USES THEREOF,” the contents of which is incorporated by reference herein in its entirety.

### BACKGROUND

Commercial agriculture and aquaculture operate on small margins and any improvement, even incremental, in performance of the plants and/or animals can provide significant cost-savings in the industry. Additionally, with the movement towards bans on the use of antimicrobials (e.g. antibiotics, antifungals, antiprotozoals) and other performance enhancing substances (e.g. growth promoting hormones) there is a need for the development of improved techniques and technologies that can be used in agriculture and aquaculture settings that do not rely on the use of antimicrobials but can be capable of enhancing the performance of plants and animals in these settings.

### SUMMARY

Described herein are methods of enhancing the performance of an animal that can include the step of administering a nutrient-spore formulation to the animal, wherein the nutrient-spore formulation can include an effective amount of spores and wherein at least one of the spores can be activated. The nutrient-spore formulation can include an effective amount of a nutrient formulation. The animal can be a chicken. The effective amount of spore can range from about 5×10² to about 5×10⁷ CFU/mL. The effective amount of the nutrient formulation can range from about 2% (v/v) to about 4% (v/v) prior to a final dilution in a water source. The animal can be a shellfish. The shellfish can be a shrimp or a prawn. The effective amount of spores can range from about 1×10² to about 1×10³ CFU/mL. The effective amount of spores can be about 9.6×10² CFU/mL. The effective amount of the nutrient formulation can range from about 2% (v/v) to about 4% (v/v) prior to any dilution in a water source. The effective amount of the nutrient formulation can be about 9.6×10⁻⁶% (v/v). The nutrient-spore formulation can be administered to the animal via a source of drinking water. In some aspects, about 50% to about 100% of the spores in the effective amount of spores can be activated.

Also described herein are methods of enhancing the performance of a plant that can include the step of administering a nutrient-spore formulation to the plant, wherein the nutrient-spore formulation can include an effective amount of spores, wherein at least one of the spores can be activated. The effective amount of spores can range from about 1×10⁵ CFU/mL to about 5×10⁷ CFU/mL. The effective amount of spores can be about 5×10⁶ CFU/mL. The nutrient-spore formulation further can include an effective amount of a nutrient formulation. The effective amount of the nutrient formulation can range from about 2% (v/v) to about 4% (v/v) prior to a dilution into a water source.

Also described herein are methods that can include the steps of mixing an amount of a nutrient formulation with an amount of a spore formulation to form a nutrient-spore formulation, wherein the spore formulation can include spores, and wherein the nutrient formulation comprises an L-amino acid, a buffer, and a preservative; and heating the nutrient-spore formulation to form an activated nutrient-spore formulation, wherein about 50% to about 100% of the spores are activated, wherein the steps of mixing and heating can be performed at the point of use. The preservative can be a germination inhibitor. The steps of mixing and heating can be performed within 1 second to 5 minutes of each other. The method can further include the step of diluting the activated nutrient-spore formulation to form a diluted-activated nutrient-spore formulation. The method can further include the step of administering the diluted-activated nutrient spore formulation to an animal or a plant. The diluted-activated nutrient-spore formulation can further include an effective amount of spores. The effective amount of spores can range from about 1×10² to about 5×10⁷ CFU/mL. The effective amount of spores can range from about 1×10² to about 1×10³ CFU/mL. The effective amount of spores can range from about 1×10⁶ CFU/mL to about 5×10⁶ CFU/mL. The method can further include the step of administering the activated nutrient-spore formulation to a plant or animal. The activated nutrient-spore formulation can include an effective amount of spores. The effective amount of spores can range from about 1×10² to about 5×10⁷ CFU/mL. The effective amount of spores can range from about 1×10² to about 1×10³ CFU/mL. The effective amount of spores can range from about 1×10⁶ CFU/mL to about 5×10⁶ CFU/mL.

In some aspects of the methods described herein, the activated nutrient-spore formulation or the diluted-activated nutrient-spore formulation can be administered to the animals via drinking water or the plants via irrigation water. In some aspects of the methods described herein, the nutrient-spore formulation can be heated to about 42° C. during the step of heating. In some aspects of the methods described herein, the step of heating can occur for about 2 to about 60 minutes.

Also described herein are nutrient-spore formulations that can include an effective amount of spores; an effective amount of a nutrient formulation; and a diluent. The effective amount of spores can range from about 1×10⁷ CFU/mL to about 1×10⁹ CFU/mL. The effective amount of the nutrient formulation can range from about 2% (v/v) to about 4% (v/v). The diluent can be water. In some aspects, about 50% to about 100% of the spores can be activated.

Also described herein are formulations that can include an effective amount of spores, wherein about 50% to about 100% of the spores can be activated and wherein the effective amount of spores can range from about 1×10² CFU/mL to about 1×10⁷ CFU/mL; a nutrient formulation, wherein the nutrient formulation comprises an L-amino acid, a buffer, a preservative, and a source of potassium ions; and a diluent. The nutrient formulation can further include a sugar. The effective amount of spores can range from about 1×10² to about 5×10⁷ CFU/mL. The effective amount of spores can be sufficient to improve a performance characteristic of a chicken. The effective amount of spores can be about 9.6×10². The effective amount of spores can be sufficient to improve a performance characteristic of a shrimp or a prawn. The effective amount of spores can range from about 1×10⁶ CFU/mL to about 5×10⁶ CFU/mL. The effective amount of spores can be about 5×10⁶ CFU/mL. The effective amount of spores can be sufficient to improve a performance characteristic of a plant.

### BRIEF DESCRIPTION OF THE DRAWINGS

Further aspects of the present disclosure will be readily appreciated upon review of the detailed description of its various aspects, described below, when taken in conjunction with the accompanying drawings.

FIG. 1 shows a flow-diagram showing an aspect of forming a nutrient-spore formulation.

FIG. 2 shows a flow-diagram showing an aspect of forming a nutrient-spore formulation.

FIG. 3 shows a flow-diagram showing an aspect of forming a nutrient-spore formulation.

FIG. 4 shows a flow-diagram showing an aspect of forming a nutrient-spore formulation.

FIG. 5 shows a flow-diagram showing an aspect of a method for using a nutrient-spore formulation.

FIG. 6 shows a flow-diagram showing an aspect of a method for using a nutrient-spore formulation.

FIG. 7 shows a flow-diagram showing an aspect of a method for using a nutrient-spore formulation.

FIG. 8 shows a flow-diagram showing an aspect of a method for using a nutrient-spore formulation.

FIG. 9 shows an image of three aquariums, each under control (left), calcium carbonate only treatment (middle), or treatment with an activated nutrient-spore formulation (right).

### DETAILED DESCRIPTION

Before the present disclosure is described in greater detail, it is to be understood that this disclosure is not limited to particular aspects described, and as such may, of course, vary. It is also to be understood that the terminology used herein is for the purpose of describing particular aspects only, and is not intended to be limiting.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure. Any recited method can be carried out in the order of events recited or in any other order that is logically possible.

Where a range is expressed, a further aspect includes from the one particular value and/or to the other particular value. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used in the specification and the appended claims, the singular forms “a,” “an,” and “the” include plural referents unless the context clearly dictates otherwise.

As used herein, “about,” “approximately,” “substantially,” and the like, when used in connection with a numerical variable, can generally refers to the value of the variable and to all values of the variable that are within the experimental error (e.g., within the 95% confidence interval for the mean) or within +/−10% of the indicated value, whichever is greater. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Aspects of the present disclosure will employ, unless otherwise indicated, techniques of molecular biology, microbiology, chemistry, organic chemistry, biochemistry, botany and the like, which are within the skill of the art. Such techniques are explained fully in the literature.

### Definitions

Unless stated otherwise herein, the following terms will have the following definitions as the terms are used herein.

As used herein, “additive effect” can refer to an effect arising between two or more molecules, compounds, substances, factors, or compositions that is equal to or the same as the sum of their individual effects.

As used herein, “control” can refer to an alternative subject or sample used in an experiment for comparison purposes and included to minimize or distinguish the effect of variables other than an independent variable.

As used herein, “concentrated” in the context of a liquid formulation can refer to a formulation that has less liquid per volume as compared to a formulation with the same components but more liquid volume.

As used herein, “diluted” can refer to a compound, composition, ingredient, formulation, and/or any component thereof that is distinguishable from its source in that the concentration or number of molecules of that compound, composition, ingredient, formulation and/or any component thereof per volume is less than that of its source.

As used herein, “effective amount” can generally refer to the amount of a composition or formulation and/or component thereof described herein that can elicit a desired biological or chemical response of a tissue, system, animal, plant.

As used herein, “negative control” refers to a “control” that is designed to produce no effect or result, provided that all reagents are functioning properly and that the experiment is properly conducted. Other terms that are interchangeable with “negative control” include “sham,” “placebo,” and “mock.”

The terms “sufficient” and “effective,” as used interchangeably herein, can refer to an amount (e.g. mass, volume, dosage, concentration, and/or time period) needed to achieve one or more desired result(s). For example, a therapeutically effective amount refers to an amount needed to achieve one or more therapeutic effects.

### Discussion

Commercial agriculture and aquaculture operate on small margins and any improvement, even incremental, in performance of the plants and/or animals can provide significant cost-savings in the industry. Additionally, with the movement towards bans on the use of antimicrobials (e.g. antibiotics, antifungals, antiprotozoals) and other performance enhancing substances (e.g. growth promoting hormones) there is a need for the development of improved techniques and technologies that can be used in agriculture and aquaculture settings that do not rely on the use of antimicrobials but can be capable of enhancing the performance of plants and animals in these settings.

With that said, described herein are nutrient formulations and spore formulations that can be mixed to form a nutrient-spore formulation that can be administered to animals and/or plants and/or applied to waste water. The nutrient-spore formulation can be heated to activate the spores within the nutrient-spore formulation. The activated nutrient-spore formulation can be subsequently administered to the animals and/or plants and/or applied to wastewater. The nutrient-spore formulation can be formed from the nutrient formulation and spore formulation as well as activated by heating on-site at the point of use. Other compositions, compounds, methods, features, and advantages of the present disclosure will be or become apparent to one having ordinary skill in the art upon examination of the following drawings, detailed description, and examples. It is intended that all such additional compositions, compounds, methods, features, and advantages be included within this description, and be within the scope of the present disclosure.

Nutrient, Spore, and Nutrient-Spore Formulations

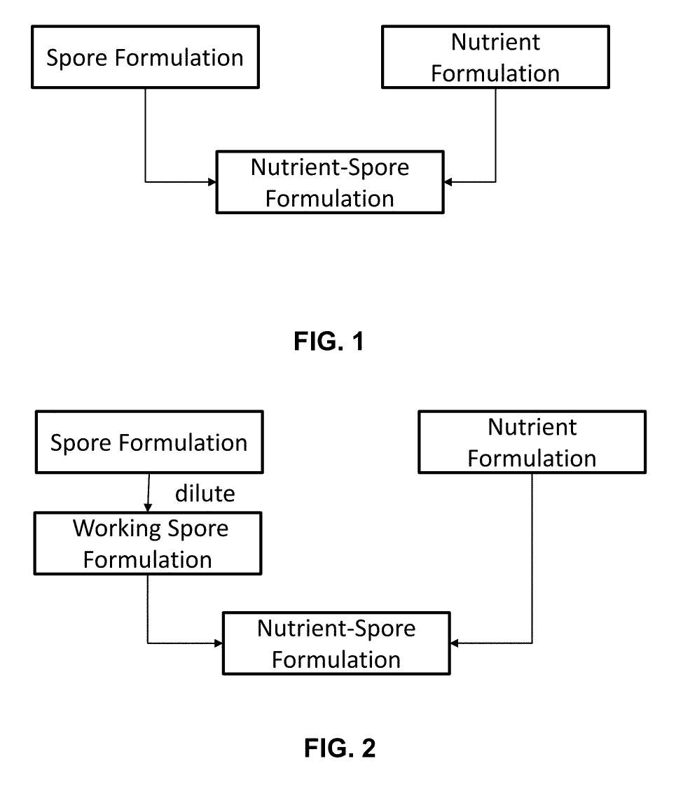

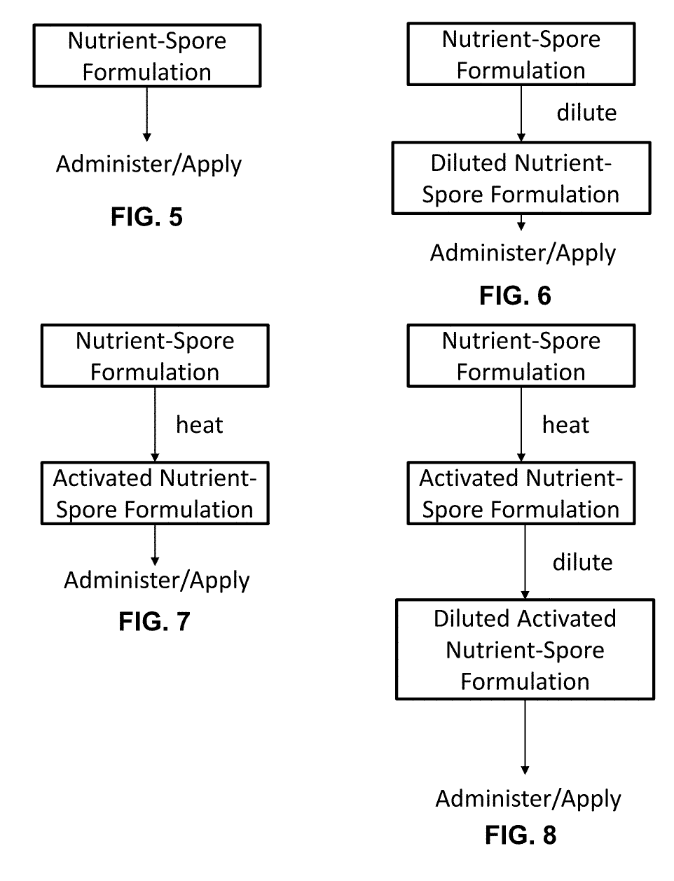

Described herein are nutrient formulations and spore formulations that can be mixed together to form a nutrient-spore formulation (see e.g. FIGS. 1-4). The nutrient-spore formulations can be used directly or be otherwise manipulated prior to administration and/or application to plants, animals, and/or waste water (see e.g. FIGS. 5-8). Methods of using the nutrient, spore, and nutrient-spore formulations described herein are described in greater detail elsewhere herein. The formulations described herein can be administered to, without limitation, animals, plants, and/or applied to waste water or used in other forms of bioaugmentation/environmental remediation. The nutrient-spore formulations described herein can improve and/or enhance a performance characteristic of the animal and/or plant to which it is administered.

Nutrient Formulations

Described herein are nutrient formulations that can contain one or more L-amino acids, D-glucose, D-fructose, a biological buffer, a potassium ion source, a natural osmoprotectant, and/or a preservative. The nutrient formulation can be mixed with a spore formulation described elsewhere herein to form nutrient-spore formulation (see e.g. FIGS. 1-4). In some aspects, the nutrient formulation can be a concentrated nutrient formulation that can be diluted prior to use and/or mixing with a spore formulation described herein. In some instances, the concentrated nutrient formulation can also be referred to as a starting nutrient solution. The concentrated nutrient formulation can be considered a 100% formulation that can be subsequently diluted prior to use and/or mixing with a spore formulation.

In some aspects, the nutrient formulation can be directly mixed with a spore formulation or working spore formulation to form a nutrient-spore formulation as described elsewhere herein (see also e.g. FIGS. 1-2). In some aspects, the nutrient formulation can be mixed with a spore formulation or a working spore formulation described elsewhere herein and one or more other diluents, including without limitation, water to form a nutrient-spore formulation. The nutrient formulation can be diluted about 2, 3, 4, 5, 6, 7, 8, 9, 10, 15, 20, 35, 30, 35, 40, 45, 50, 55, 60, 65, 70, 75, 80, 85, 90, 95, 100, 200, 300, 400, 500, 600, 700, 800, 900, 1000, 10,000, or 1×10⁵ to about 1×10⁶ fold or any range or value therein in the resulting nutrient-spore formulation. In some aspects, the nutrient formulation can be diluted 0.01, 0.1, 1, 5, 10, 15, 20, 30, 40, 50% (v/v) of the concentrated (e.g. a 100% concentrated) nutrient formulation in the nutrient-spore formulation.

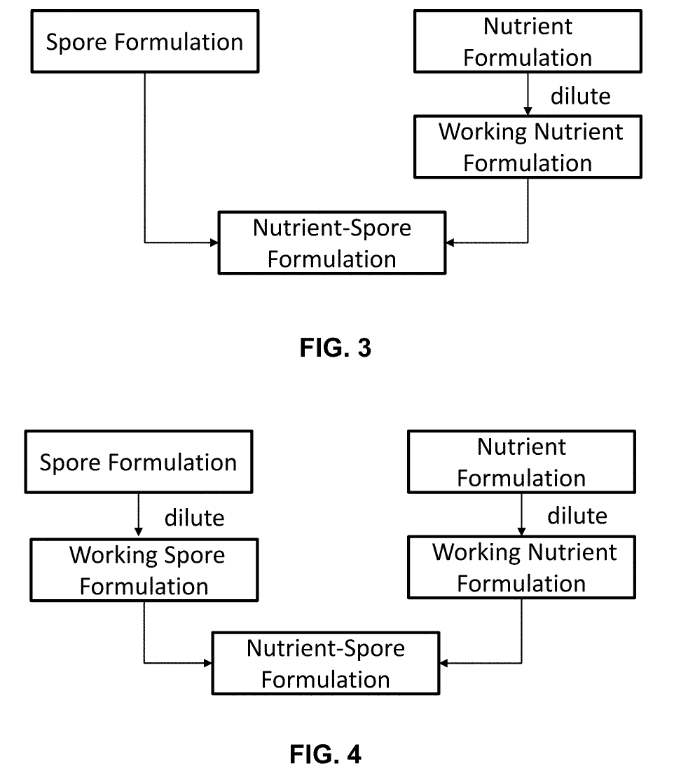

In some aspects, the nutrient formulation can be diluted prior to mixing with a spore formulation or working spore formulation to form a working nutrient formulation (see e.g. FIGS. 3-4). Suitable diluents include, but are not limited to, water. The nutrient formulation can be diluted about 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, 1×10⁵, to about 1×10⁶ fold or any range or value therein in the resulting working nutrient formulation. In some aspects, the nutrient formulation can be diluted 0.01, 0.1, 1, 5, 10, 15, 20, 30, 40, 50% (v/v) of the 100% concentrated nutrient formulation in the working nutrient formulation. In some aspects, a concentrated nutrient formulation can be diluted about 25-fold to form a working nutrient-spore formulation. In some aspects, a concentrated nutrient formulation can be diluted about 50-fold to form a working nutrient-spore formulation.

The nutrient formulation can include one or more L-amino acids. In some aspects, the L-amino acid(s) included in the nutrient formulation can be L-alanine, L-asparagine, L-valine, L-cysteine, and/or any combination thereof. In some aspects the L-amino acid included in the formulation can be L-alanine. The L-amino acids can be provided in the form of any suitable source, such as their pure forms and/or a hydrolysate of soy protein. In some aspects, the amount of each of the L-amino acids present in the nutrient formulation can range from about 8.9 to about 133.5 g/L, about 13.2 to about 111.25 g/L, or about 17.8 to about 89 g/L. In some aspects, the amount of each of the L-amino acids in the concentrated nutrient formulation can range from about 8.9 to about 133.5 g/L, about 13.2 to about 111.25 g/L, or about 17.8 to about 89 g/L. In some aspects, the concentrated nutrient solution can contain about 89 g/L L-alanine. The amount of each of an L-amino acid present in a working nutrient formulation or other dilution of a working nutrient formulation can be calculated based on a dilution factor as described above.

The nutrient solution can contain an amount of D-glucose and/or D-fructose. In some aspects, the amount of D-glucose and/or D-fructose in the concentrated nutrient formulation can each range from about 18 to about 54 g/L, about 27-45 g/L, or 30-40 g/L. In some aspects, the amount of D-glucose and/or D-fructose in the concentrated nutrient formulation can each range from about 18 to about 54 g/L, about 27-45 g/L, or 30-40 g/L. In some aspects, the amount of D-glucose can be 0. In other words, in these aspects D-glucose is not in included in the nutrient formulation. In some aspects, the amount of D-fructose can be 0. In other words, in these aspects D-fructose is not in included in the nutrient formulation. The amount present in a working nutrient formulation can be calculated based on a dilution factor as described above.

The nutrient solution can contain one or more sources of potassium ions. In some aspects, KCl can be included as a source of potassium ions in the nutrient formulation. The amount of KCl in the nutrient formulation can range from about 7.4-22.2 g/L, about 11.1-18.5 g/L, or about 14-16 g/L. The amount of KCl in a concentrated nutrient formulation can be included at about 7.4-22.2 g/L, about 11.1-18.5 g/L, or about 14-16 g/L. In some aspects, the amount of KCl can be 0. In other words, in some aspects KCl is not included in the nutrient formulation.

The nutrient formulation can contain one or more biological buffers. As used herein, a “biological buffer” is a formulation or compound that can buffer the nutrient formulation and/or nutrient-spore formulation, to maintain the formulation at the proper pH for spore germination (about pH 6-8). In some aspects, monosodium phosphate can be included in the nutrient formulation as a biological buffer. The monosodium phosphate can be included in a nutrient formulation at about 10-36 g/L, about 15-30 g/L, or about 20-24 g/L. The monosodium phosphate can be included in a concentrated nutrient formulation at about 10-36 g/L, about 15-30 g/L, or about 20-24 g/L. In some aspects, the monosodium phosphate can be included in a concentrated nutrient formulation at about 20 g/L. In some aspects, disodium phosphate can be included in a nutrient formulation as a buffer. The disodium phosphate can be included in a nutrient formulation at about 30-90 g/L, about 21.3-75 g/L, or about 28.4-60 g/L. The disodium phosphate can be included in a concentrated nutrient formulation at about 30-90 g/L, about 21.3-75 g/L, or about 28.4-60 g/L. In some aspects, a concentrated nutrient formulation the amount of disodium phosphate can be about 60 g/L. The amount present in a working nutrient formulation can be calculated based on the dilution factor as described above. In some aspects, the amounts of KCl, monosodium phosphate, and/or disodium phosphate can be adjusted such that the pH in the nutrient formulation and/or nutrient-spore solution can be about 6, about 7, or about 8.

The nutrient formulation can contain an osmoprotectant compound or composition. As used herein, “osmoprotectant” refers to a compound or compositions that can be soluble and are capable of counteracting alterations in osmolarity of a solution or environment (e.g. a cell) they are present in. In some aspects, ectoine, a natural osmoprotectant produced by some species of bacteria, can be included in the nutrient formulation. The amount of ectoine in the concentrated nutrient formulation can range from about 0.625 to about 4.375 g/L, about 1.875-3.125 g/L, or 2-3 g/L. In some aspects, the amount of ectoine can be 0. In other words, ectoine is not in included in the nutrient formulation. The amount present in a working nutrient formulation can be calculated based on the dilution factor as described above.

The nutrient formulation can include one or more preservatives. The preservative(s) can be beneficial for long-term storage and/or inhibit spore germination. Suitable preservatives can include, without limitation, NaCl, D-alanine, potassium sorbate, and chemical preservatives. In some aspects, NaCl can be included in a nutrient formulation at a relatively high concentration and can range from about 29-117 g/L, about 43-88 g/L, or about 52-71 g/L. In some aspects, NaCl can be included in a concentrated nutrient formulation at a relatively high concentration and can range from about 29-117 g/L, about 43-88 g/L, or about 52-71 g/L. In some aspects, D-alanine can be included in a nutrient formulation at about 8-116 g/L, 26-89 g/I, or about 40-50 g/L. In some aspects, D-alanine can be included in a concentrated nutrient formulation at about 8-116 g/L, 26-89 g/I, or about 40-50 g/L. In some aspects, potassium sorbate can be included in a nutrient formulation at about 1.25-8.75 g/L, about 3.75-6.25 g/L, or about 4.5-5.5 g/L. In some aspects, potassium sorbate can be included in a concentrated nutrient formulation at about 1.25-8.75 g/L, about 3.75-6.25 g/L, or about 4.5-5.5 g/L. The amount present in a working nutrient formulation can be calculated based on the dilution factor as described above.

Chemical preservatives can be preservatives with active ingredients of methyl chloro isothiazolinone (about 1.15% to about 1.18% v/v) and methyl isothiazolinone (about 0.35-0.4% v/v); preservatives with the active ingredients of diazolidinyl urea (about 30%), methylparaben (about 11%), and propylparaben (about 3%); and preservatives with only the active ingredient of methylparaben; and other preservatives with the methyl paraben, propylparaben, and diazolidinyl urea). Non-limiting examples of chemical preservatives with methyl chloro isothiazolinone and methyl isothiazolinone as active ingredients are Linguard ICP and KATHON™ CG. A non-limiting example of a chemical preservative with diazolidinyl urea, polyparaben, and methylparaben as active ingredients includes Germaben II. Where the active ingredients of the chemical preservative are methyl chloro isothiazolinone and methyl isothiazolinone, the chemical preservative can be included in a concentrated nutrient solution at about 0.8-3.3 g/L, 1.2-2.7 g/L, or 1.6-2.2 g/L. Where the active ingredient(s) of the chemical preservative is diazolidinyl urea, methylparaben, and/or propylparaben, the chemical preservative can be included in a nutrient solution at about 0.3 to about 1% (wt/wt). Where the active ingredient(s) of the chemical preservative is diazolidinyl urea, methylparaben, and/or propylparaben, the chemical preservative can be included in a concentrated nutrient solution at about 0.3 to about 1% (wt/wt).

In some aspects, the amount of a chemical preservative having diazolidinyl urea, methylparaben, and propylparaben can be included in the nutrient formulation at about 10 g/L. In the case of methylparaben, the preservative can be included in a nutrient solution at about 0.27-1.89 g/L, about 0.81-1.35 g/L, or about 1.0-1.18 g/L. In the case of methylparaben, the preservative can be included in a concentrated nutrient solution at about 0.27-1.89 g/L, about 0.81-1.35 g/L, or about 1.0-1.18 g/L. In some aspects, where the nutrient formulation can be used to generate a nutrient-spore formulation effective for poultry, shrimp, or other shellfish, the preservative can include an amount of methylparaben and potassium sorbate. In some aspects, such as those where the nutrient solution can be used to generate a nutrient-spore formulation effect for plants and/or waste water, the nutrient-spore formulation can include an amount of Linguard ICP or KATHON™ CG. The amount(s) present in a working nutrient formulation or other dilution can be calculated based on the dilution factor as described above.

The nutrient formulation can include a biological buffer. Suitable biological buffers can include, but are not limited to, a phosphate buffer, HEPES sodium salt, and/or a Tris-buffer. In some aspects, a phosphate buffer can include about 10 to about 36 g/L, about 15 to about 30 g/L, or about 20 to about 24 g/L monosodium phosphate and disodium phosphate in a weight range of about 30 to about 90 g/L, about 21.3 to about 75 g/L, or about 28.4 to about 60 g/L. In addition to, or in place of, the monosodium/disodium phosphate buffer, the nutrient formulation can include a Tris base in a weight range of about 15 to about 61 g/L, about 24 to about 43 g/L, or about 27-33 g/L; and/or a HEPES buffer in a weight range of about 32.5 97.5 g/L, about 48.75-81.25 g/L, and about 60-70 g/L.

The nutrient formulation can contain other standard ingredients including, but not limited to, surfactants, additional preservatives, buffers, diluents, and/or other ingredients that are typically included in a nutrient formulation and/or spore formulation. In some aspects, the nutrient formulation can be a nutrient formulation that is described in U.S. patent application Ser. No. 15/479,773, which is incorporated by reference herein as if expressed in its entirety.

Spore Formulations

Described herein are spore formulations that can contain one or more Bacillus species of spores, including but not limited to, Bacillus licheniformis, Bacillus subtillis, Bacillus amyloliquiefaciens, Bacillus polymyxa, Bacillus thuringiensis, Bacillus megaterium, Bacillus coagulans, Bacillus lentus, Bacillus clausii, Bacillus circulans, Bacillus firmus, Bacillus lactis, Bacillus laterosporus, Bacillus laevolacticus, Bacillus polymyxa, Bacillus pumilus, Bacillus simplex, Bacillus sphaericus, Bacillus sonorensis, Bacillus, horneckiae, Bacillus axarquiensis, Bacillus mucilaginosus, Bacillus olivae, and any combinations thereof. The spore formulations can contain 1, 2, 3, 4, 5, 6, 7, 8, 9, 10, 11, 12, 13, 14, 15, 16, 17, 18, 19, 20 or more species or strains of Bacillus spores. In some aspects, the spore formulation can contain 1, 2, or 3 different species and/or 1, 2, or 3 different strains of spores. In some aspects, the spore formulation can contain 3 strains of Bacillus bacteria.

Each species or strain included in the spore formulation can be present, when included, at an amount such that the percent of each species or strain included in the spore formulation rages from any non-zero percent up to 100% (by weight) of the spores contained in the spore formulation. For example, where the spore formulation only includes 1 species or strain of spores, then that species or strain is included in the spore formulation at 100% (by weight) of the spores. Stated differently, in this example 100% (by weight) of the spores are a single species or strain. In aspects where 2 different strains and/or species are included in the spore formulation, the first species or strain and the second species and/or strain can be included in the spore formulation at any non-zero percent up to any non-zero percent that is greater than zero but less than 100 percent. The maximum inclusion percent of the first strain is determined by how much the second strain is included in the spore formulation and vice versa. In some aspects, the first strain or species can be included at about 0.1%, 1%, 2%, 3%, 4%, 5%, 6%, 7%, 8%, 9%, 10%, 11%, 12%, 13%, 14%, 15%, 16% 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60% 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or about 99% to about 99.9% by weight of the total amount of spores in the spore formulation. In some aspects the second strain or species can be included at about 0.1%, 1%, 2%, 3%, 4%, 5%, 6%, 7%, 8%, 9%, 10%, 11%, 12%, 13%, 14%, 15%, 16% 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60% 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or about 99% to about 99.9% by weight of the total amount of spores in the spore formulation. In some aspects where 3 different strains and/or species is present in the spore formulation, each strain and/or species included in the spore formulation can be included at about 0.1%, 0.2%, 1%, 2%, 3%, 4%, 5%, 6%, 7%, 8%, 9%, 10%, 11%, 12%, 13%, 14%, 15%, 16% 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60% 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or about 99% to about 99.8% by weight of the total amount of spores in the spore formulation. As will be appreciated by those of ordinary skill in the art, when 3 strains and/or species are each included at a non-zero amount, that each one is present at a percent that is a non-zero percent less than 100% by weight because two other strains and/or species is present and that the exact percent inclusion of each strain can be calculated based on the total amount of spores and the amount of inclusion of the other two strains and/or species where the total of all 3 species and/or strains is 100% by weight using simple calculations within the purview of one of ordinary skill in the art.

In some of these aspects, 2 strains of the Bacillus bacteria can each be a strain of the species Bacillus licheniformis and the third strain is a species of Bacillus subtilis. In some of these aspects, about 80% of the formulation can be Bacillus licheniformis (40% of each strain) and 20% of the spores in the spore formulation can be is Bacillus subtilis. In some aspects, the spores of the strain(s) included in the spore formulation can be mixed with water or other suitable carrier and/or organic salts. In some aspects, the spore formulation includes xanthan gum.

The Bacillus species that can be contained in the spore formulations can produce and/or be capable of producing one or more enzymes including, but not limited to, proteases, amylases, lipases, glycosidases, cellulases, esterases, and xylanases. Tests and assays for determining the production of such enzymes from a Bacillus species are generally known in the art and to one of ordinary skill in the art.

The spore formulation can contain about 0.1%, 1%, 2%, 3%, 4%, 5%, 6%, 7%, 8%, 9%, 10%, 11%, 12%, 13%, 14%, 15%, 16% 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60% 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, or about 89% to about 90% by weight of spores. In some aspects, the spore formulation contains about 5% by weight spores. The spore formulation can be and/or include a powder or other dry form (e.g. spray-dried form of a liquid spore concentrate, or lyophilized spore formulation) containing spores. The spore formulation can be and/or include a liquid containing spores. The total concentration of spores in the spore formulation can range from about 1×10⁵ CFU/mL or spores/g to 1×10¹⁴ CFU/mL or spores/g or any specific concentration or range therein. The total concentration of spores in the spore formulation can be about 1, 1.125, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, or 9.75×10⁵, 10⁶, 10⁷, 10⁸, 10⁹, 10¹⁰, 10¹¹, 10¹², 10¹³, or 10¹⁴ CFU/mL or spores/g or any range or other value therein. Any one specific spore species can be present in the spore formulation at a concentration that can range from about 1×10⁵ CFU/mL to 1×10¹⁴ CFU/mL or any specific range therein. The concentration of any one specific spore species or strain present in the spore formulation can be about 1, 1.125, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, or 9.75×10⁵, 10⁶, 10⁷, 10⁸, 10⁹, 10¹⁰, 10¹¹, 10¹², 10¹³, or 10¹⁴ CFU/mL or spores/g or any range or other value therein. The spore formulation can be biodegradable. In some aspects, the concentrated spore formulation can contain about 1-9×10⁹ or 10¹⁰ CFU/mL or spores/g. In some aspects, the concentrated spore formulation can contain about 10¹⁰ CFU/mL or spores/g. In some aspects, the spore formulation can be a spore formulation described in U.S. Pat. Pub. 2015/0118203, which is incorporated by reference as if expressed in its entirety herein.

The spore formulation can be mixed with a nutrient formulation to form a nutrient-spore formulation as described in greater detail herein (see e.g. FIGS. 1-4). In this context, the spore formulation can be considered a concentrated spore formulation. The spore formulation can be a concentrated formulation that can be diluted one or more (e.g. 2, 3, 4, 5, 6, 7, 8, 9, 10 or more) times prior to administration or application. In some instances the concentrated spore formulation can be referred to as a starting spore formulation. The concentrated spore formulation can be diluted with one or more diluents. Suitable diluents can be, without limitation, water and/or a nutrient formulation described herein. The diluent(s) can be compounds or compositions that are generally recognized as safe (GRAS).

In some aspects, the concentrated spore formulation can be directly diluted in a nutrient formulation described herein to form a nutrient-spore formulation (see e.g. FIGS. 1 and 3). In other words, the concentrated spore formulation can be directly mixed with a nutrient formulation described elsewhere herein. In some aspects, at least one of the diluents can be a nutrient formulation described elsewhere herein. In some aspects, the only diluent is a nutrient formulation described elsewhere herein. The total concentration of spores in the nutrient-spore formulation can be about 1, 1.125, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, or 9.75×10⁵, 10⁶, 10⁷, 10⁸, 10⁹, 10¹⁰, 10¹¹, 10¹², or 10¹³ CFU/mL or any range or other value therein. The concentration of any one specific spore species or strain present in the nutrient-spore formulation can be about 1, 1.125, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, or 9.75×10⁵, 10⁶, 10⁷, 10⁸, 10⁹, 10¹⁰, 10¹¹, 10¹², or 10¹³ CFU/mL or any range or other value therein. The spore formulation can be diluted about 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, 1×10⁵, to about 1×10¹³-fold or any range or value therein in the resulting nutrient-spore formulation.

In some aspects, the concentrated spore solution can be diluted one or more (e.g. 2, 3, 4, 5, 6, 7, 8, 9, 10 or more) times to form a working spore solution that can be subsequently mixed with a nutrient formulation to form a nutrient-spore solution as described elsewhere herein (see e.g. FIGS. 2 and 4). In some aspects, at least one of the diluents can be a nutrient formulation described elsewhere herein. In some aspects, the only diluent is a nutrient formulation described elsewhere herein. The total concentration of spores in the working spore formulation can be about 1, 1.125, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, or 9.75×10⁵, 10⁶, 10⁷, 10⁸, 10⁹, 10¹⁰, 10¹¹, 10¹², or 10¹³ CFU/mL or any range or other value therein. The concentration of any one specific spore species or strain present in the working spore formulation can be about 1, 1.125, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, or 9.75×10⁵, 10⁶, 10⁷, 10⁸, 10⁹, 10¹⁰, 10¹¹, 10¹², or 10¹³ CFU/mL or any range or other value therein. The spore formulation can be diluted about 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, 1×10⁵, to about 1×10¹³-fold or any range or value therein in the resulting working spore formulation.

In some aspects, a concentrated spore formulation can be diluted about 10-fold to form a working nutrient-spore formulation. In some aspects, a concentrated spore formulation can be diluted about 100-fold to form a working nutrient-spore formulation. In some aspects, a concentrated spore formulation can be diluted about 1000-fold to form a working nutrient-spore solution.

Nutrient-Spore Formulations

Also provided herein are nutrient-spore formulations that can be generated by mixing a spore formulation and a nutrient formulation together (see e.g. FIGS. 1-4). As described above with respect to then nutrient formulation and spore formulation, the nutrient-spore formulation can contain a dilution of a concentrated nutrient formulation and/or a dilution of a concentrated spore formulation.

The amount of the spore formulation present in the nutrient-spore formulation can be a 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, 1×10⁵, to about 1×10¹³-fold or any range or other value therein dilution of a concentrated spore solution. In some aspects, the total concentration of spores in the nutrient-spore formulation can be about 1, 1.125, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, or 9.75×10⁵, 10⁶, 10⁷, 10⁸, 10⁹, 10¹⁰, 1011, 10¹², or 10¹³ CFU/mL or any range or other value therein. The concentration of any one specific spore species or strain present in the nutrient-spore formulation can be about 1, 1.125, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, or 9.75×10⁵, 10⁶, 10⁷, 10⁸, 10⁹, 10¹⁰, 10¹¹, 10¹², or 10¹³ CFU/mL or any range or other value therein. In some aspects, the total concentration of spores in the nutrient-spore formulation can be about 1-9×10⁹, about 1-2.5×10⁹, or about 1×10⁹ CFU/mL. In some aspects, the total concentration of spores in the nutrient-spore formulation can be about 1-2.5×10⁸, 1.125×10⁸, 2×10⁸, or 2.5×10⁸ CFU/mL. In some aspects, the total concentration of spores in the nutrient-spore formulation can be about 1-9×10⁷ CFU/mL. In some aspects, the total concentration of spores in the nutrient-spore formulation can be about 5×10⁷CFU/mL.

The amount of the nutrient formulation in the nutrient-spore formulation can be a 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, 1×10⁵, to about 1×10⁶ fold or any range or other value therein dilution of a nutrient formulation. In some aspects, the nutrient formulation can be diluted such that the nutrient formulation is about 0.001, 0.001, 0.01, 0.1, 1, 5, 10, 15, 20, 30, 40, to about 50% (v/v) of the nutrient-spore formulation. In some aspects, the nutrient formulation is diluted 10-fold in the nutrient-spore formulation. In some aspects, the nutrient formulation is diluted 25-fold in the nutrient-spore formulation. In some aspects, the nutrient formulation is diluted 50-fold in the nutrient-spore formulation. In some aspects, the nutrient formulation is diluted 100-fold in the nutrient-spore formulation.

In some aspects, the nutrient-spore formulation can be directly administered and/or applied to a plant, animal, and/or wastewater (see e.g. FIG. 5). In these aspects, the amounts of the spores and nutrient formulation in the final dose administered or applied can be the about same as that of the nutrient-spore formulation. Dilution can occur upon administration and/or application, such as when the diluted nutrient-spore formulation is added to drinking water, irrigation water, or other water source (e.g. aquarium water that houses shrimp (and/or other aquatic life) or wastewater). Dilution upon administration and/or application to drinking water, irrigation water, or other water source can be about a 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, or 1×10⁵ to about 1×10¹³-fold or any range or other value therein dilution.

In some aspects, the nutrient-spore formulation can be diluted prior to administration to a plant and/or animal and/or application to wastewater (see e.g. FIG. 6). The nutrient-spore formulation can be diluted about 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, 1×10⁵, to about 1×10¹³-fold or any range or other value therein prior to administration and/or application. Further dilution can occur upon administration or application, such as when the diluted nutrient-spore formulation is added to drinking water, irrigation water, or other water source (e.g. aquarium water that houses shrimp (and/or other aquatic life) or wastewater). Dilution upon administration or application to drinking water or other water source can be about a 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, or 1×10⁵ to about 1×10¹³-fold or any range or other value therein dilution.

In some aspects, the nutrient-spore formulation can be heated for a period of time to form an activated nutrient-spore formulation (see e.g. FIGS. 7-8). The activation process is described in more detail below. The activated nutrient-spore formulation can be directly administered to a plant and/or an animal without further dilution (see e.g. FIG. 7). In these aspects, the amounts of the spores and nutrient formulations in the final dose administered or applied can be about the same as that of the nutrient-spore formulation. Dilution can occur upon administration and/or application, such as when the diluted nutrient-spore formulation is added to drinking water or other water source (e.g. aquarium water that houses shrimp (and/or other aquatic life) or wastewater). Dilution upon administration and/or application to drinking water or other water source can be about a 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, 1×10⁵, to about 1×10¹³-fold or any range or other value therein dilution.

In other aspects, the activated nutrient-spore formulation can be further diluted prior to administration and/or application (see e.g. FIG. 8). Dilution of the nutrient-spore formulation can be about a 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, or 1×10⁵ to about 1×10¹³-fold or any range or other value therein dilution. Further dilution can occur upon administration and/or application, such as when the diluted nutrient-spore formulation is added to drinking water or other water source (e.g. aquarium water that houses shrimp (or other aquatic life) or wastewater). Dilution upon administration or application to drinking water or other water source can be about a 2, 3, 4, 5, 6, 7, 8, 9, 10, 15 20, 35 30, 35 40, 45, 50, 55, 60, 65, 70, 75, 80, 85, 90, 95, 100, 200, 300, 400, 500, 600, 700, 800, 900, 1000, 10,000, 1×10⁵, to about 1×10¹³-fold or any range or other value therein dilution.

Prior to any dilution that is the result of administration via a water source, the nutrient-spore formulation can contain an effective amount of spores and effective amount of the nutrient formulation. In some aspects, the effective amount of spores in the nutrient-spore formulation prior to any dilution that is the result of administration via a water source can range from about 2×10⁸ CFU/mL to about 1×10⁹ CFU/mL or any range or value therein. In some aspects, the effective spore amount in the nutrient-spore formulation prior to any dilution that is the result of administration via a water source can range from about 10⁵ to about 10¹¹ CFU/mL or any range or value therein. In some aspects, the effective spore amount in the nutrient-spore formulation prior to any dilution that is the result of administration via a water source can be about 1×10⁷ to about 1×10⁹ CFU/mL or any range or value therein. In some aspects, the effective amount of the nutrient formulation in the nutrient-spore formulation can range from about 0.001%, 0.01%, 0.1%, 1%, 1.5%, 2%, 2.5%, 3%, 3.5%, 4%, or 4.5% to about 5% v/v, or about 0.5% to about 1.5%, or about 2 to about 4% (v/v) of the total amount of the water source.

In this context, “effective amount” can refer to the amount of spores and/or nutrient composition that can be effective to improve performance of a plant or animal after administration (with or without further dilution after addition to a water source). An improvement in performance can be measured or evaluated by monitoring one or more characteristics, including but not limited to (e.g. for broiler chickens) body weight, average daily gain, mortality, disease incidence, diarrhea incidence, feed consumption, water consumption, feed conversion ratio (FCR), antibiotic use; (e.g. for egg layers) mortality, egg production cycle length, number of eggs produced, egg quality, shell quality, feed consumption, water consumption, FCR, disease incidence, egg cleanliness, antibiotic use; (e.g. for breeder chickens) mortality, egg production cycle, number of eggs produced, egg hatching percentage, egg quality, shell quality, feed consumption, water consumption, fertility, FCR, disease incidence, egg cleanliness, antibiotic use; (e.g. plants): fertilizer use, disease, water use, water additive use, plant growth, plant production (flower, fruit, consumable good), root mass, plant life span; (e.g. aquaculture) water quality: clarity of water, ammonia levels, nitrite levels, nitrate levels, disease incidence, mortality, harvest weight, meat quality, individual animal size, premium weights, antibiotic use, and additive use. “Effective amount” can also refer to the amount that can reduce the amount of, competitively exclude, and/or eliminate one or more species of pathogenic bacteria (including, but not limited to Escherichia coli and/or Salmonella) in the intestine of an animal. “Effective amount” can also refer to the amount that can reduce NH₃ and/or H₂S that can be excreted by an animal into its environment. Methods and techniques of measuring these characteristics are generally known in the art.

After addition of a nutrient-spore formulation described herein to a water source (e.g. drinking water, irrigation water, pond water, or other water source) the final dose effective amount can be determined based on the dilution of the nutrient-spore solution in the water source. In some aspects, such as those formulated for chickens, the effective amount of the spores in the water source can range from about 0.5×10² CFU/mL to about 5×10⁷ CFU/mL about 1×10⁴ CFU/mL, about 1×10⁶ CFU/mL, about 1×10⁷ CFU/mL and any range or value therein. In some aspects, such as in formulations formulated for administration to shrimp, the effective amount of the spores in the water source can be about 1 to about 9×10² CFU/mL and any value or range of values therein. In some aspects, the effective amount of the spores in the water source can be about 1 to about 9×10² to about 10⁸ CFU/mL or any value or range of values therein. In some aspects, the effective amount of the nutrient formulation in the water source can range from about 0.001%, 0.01%, 0.1%, 1%, or 1.5% to about 2% v/v of the total amount of the water source and any range of values or value therein.

In this context, “effective amount” can refer to the amount of spores and/or nutrient composition that can be effective to improve performance of a plant or animal after administration (with or without further dilution after addition to a water source). An improvement in performance can be measured or evaluated by monitoring one or more characteristics, including but not limited to (e.g. for broiler chickens) body weight, average daily gain, mortality, disease incidence, diarrhea incidence, feed consumption, water consumption, feed conversion ratio (FCR), antibiotic use; (e.g. for egg layers) mortality, egg production cycle length, number of eggs produced, egg quality, shell quality, feed consumption, water consumption, FCR, disease incidence, egg cleanliness, antibiotic use; (e.g. for breeder chickens) mortality, egg production cycle, number of eggs produced, egg hatching percentage, egg quality, shell quality, feed consumption, water consumption, fertility, FCR, disease incidence, egg cleanliness, antibiotic use; (e.g. plants): fertilizer use, disease, water use, water additive use, plant growth, plant production (flower, fruit, consumable good), root mass, plant life span; (e.g. aquaculture) water quality: clarity of water, ammonia levels, nitrite levels, nitrate levels, disease incidence, mortality, harvest weight, meat quality, individual animal size, premium weights, antibiotic use, and additive use. “Effective amount” can also refer to the amount that can reduce the amount of, competitively exclude, and/or eliminate one or more species of pathogenic bacteria (including, but not limited to Escherichia coli and Salmonella) in the intestine of an animal. “Effective amount” can also refer to the amount that can reduce NH₃ and/or H₂S that can be excreted by an animal into its environment. Methods and techniques of measuring these characteristics are generally known in the art.

Methods of Using the Nutrient, Spore, and Nutrient-Spore Formulations

The nutrient formulations and spore formulations described herein can be combined to form a nutrient-spore formulation (see e.g. FIGS. 7-8). The nutrient formulations can be provided to a user as a concentrated nutrient formulation that can be diluted and/or mixed with a spore formulation on-site at the point of use. The nutrient formulation, such as a concentrated nutrient formulation, can be provided in a separate container from a spore formulation and/or other diluents and/or other formulations that can be mixed with the nutrient formulation. In some aspects, the nutrient formulation can be provided in a separate compartment of the same container as a spore formulation and/or other diluents and/or other formulations that can be mixed in with the nutrient formulation at the point of use.

The spore formulations can be provided to a user as a concentrated nutrient formulation that can be diluted and/or mixed with a nutrient formulation on-site at the point of use. The spore formulation, such as a concentrated spore formulation, can be provided in a separate container from a nutrient formulation and/or other diluents and/or other formulations that can be mixed in with the spore formulation. In some aspects, the spore formulation can be provided in a separate compartment of the same container as a nutrient formulation and/or other diluents and/or other formulations that can be mixed in with the spore formulation at the point of use.

In some aspects, a nutrient-spore formulation can be provided to a user that can be directly administered to a plant and/or animal and/or applied to wastewater or be heated and/or diluted on-site prior to use.

The nutrient-spore formulation once formed can be heated from at a temperature ranging from about 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., or 54° C. to about 55° C., about 38° C., 39° C., 40° C., 41° C., 42° C., 43° C., 44° C., 45° C., 46° C., 47° C., 48° C., or 49° C. to about 50° C., about 41° C., 42° C., or 43° C. to about 44° C. to form an activated nutrient-spore formulation. In some aspects, the nutrient-spore formulation can be heated to about 42° C. Heating can take place prior to administration or application of the nutrient-spore formulation. The nutrient-spore formulation can be heated for about 2, 3, 4, 5, 6, 7, 8, 9, 10, 15, 20, 25, 30, 35, 40, 45, 50, 55, 60, 70, 80, 90, 100, 110, or about 120 minutes or any value or range of values therein. This heating can stimulate the spores in the nutrient-spore formulation to begin the germination process but remain at stage in the germination process that will allow the spores to survive chemicals or other substances in a water source via which the nutrient-spore formulation is administered and/or applied. This is referred to herein as “activation”. In some aspects, the heating can result in about 50, 55, 60, 65, 70, 75, 80, 85, 90, 91, 92, 93, 94, 95, 96, 97, 98, 99, 99.5, 99.9, or 100 percent or any value or range of values therein of the spores in the nutrient-spore formulation being activated. In other words, the activated nutrient-spore solution, or diluted activated nutrient spore solution can contain about 50, 55, 60, 65, 70, 75, 80, 85, 90, 91, 92, 93, 94, 95, 96, 97, 98, 99, 99.5, 99.9, or 100 (or any value or range of values therein) percent activated spores.

Activation of the spores can be determined by evaluating the germination of the spores after activation. If the spores germinated, then it can be assumed that they were activated. Spores in the nutrient-spore solution (and any spore-containing solution described herein) can be evaluated for germination using phase contrast microscopy. Germinated spores lose their refractivity due to the influx of water and are phase-dark. Non-germinated spores remain refractive and appear phase-bright. Spores that are germinated and not can be determined by counting the number in several fields that are phase-bright or phase-dark. Such techniques will be appreciated by those of ordinary skill in the art.

After heating, the activated nutrient-spore formulation can be directly administered to a plant and/or animal and/or applied to wastewater. Administration and/or application of an activated nutrient-spore solution can be within 1 second to 1 hour, 1 second to 5 minutes, 1 second to 2 minutes, or 1 second to 1 minute (or any value or range of values there) after heating is completed. Administration and/or application of an activated nutrient-spore solution can be within 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, or 59 to 60 seconds or minutes. Administration can be by any suitable route. The activated nutrient-spore formulation can be co-administered with one or more other products routinely administered to plants and animals. In some aspects, the activated nutrient-spore formulation can be co-administered to pond or tank water for aquaculture with a pond additive such as calcium carbonate and/or ECOCharger™ Pond Powder (NCH Life Sciences).

In smaller-scale operations, administration can be by non-bulk methods such as orally, hand watering, or by manual disbursement into a water source (e.g. trough, tank, aquarium, pond, etc.) In large scale operations, or other operations where automatic water distribution and/or management occurs, the dilution, mixing, heating, and/or administration of the nutrient, spore, and nutrient-spore formulations described herein can be automatically managed by a suitable system. The system can be configured to administer a nutrient-spore formulation, a diluted nutrient-spore formulation, an activated nutrient-spore formulation, and/or a diluted-activated nutrient-spore formulation as described herein directly and automatically to a water source, such as drinking water and/or waste water. An example system can include a spore container to store spores or a spore formulation, a nutrient container to store a nutrient formulation for the spores, an arrangement of valves and tubes, a reciprocating pump, a mixing tube, and a holding tank. In a drawing phase of the system, a controller can control the reciprocating pump or other pumping mechanism to draw a ratioed volume of the spores or spore formulation, the nutrient formulation, and water through the valves and tubes. During an expelling phase of the system, the controller can control flow control valves to direct the spore formulation, nutrient formulation, and water through the mixing tube and into the holding tank. During a flushing phase, the controller can flow water through the mixing tube and other valves and tubes, to clear them of the mixture of spore formulation, nutrient formulation, and/or nutrient-spore formulation. Once the nutrient-spore formulation is expelled and flushed into the holding tank, the controller can also direct a heater to heat the nutrient-spore formulation in the holding tank. The nutrient spore formulation can be heated, in various cases, at a predetermined rate, over a predetermined period of time, and/or to a predetermined temperature. Once the mixture reaches the target temperature, the controller can also direct the system through a number of other phases of operation, including cooling and purging phases. Due to the heat and the nutrients, the spores in the nutrient-spore formulation progress through germination to a type of metastable state (also referred to herein as an activated state) in which most of the spores are neither dormant nor in the vegetative growth phase. From that state, the mixture can be mixed into the drinking water of animals (or irrigation water of plants) to facilitate digestion according to one example. In that context, the controller can control the rate and amount of the mixture provided to a water distribution system for animals or plants, depending upon the type of animal drinking from it or the plant being irrigated.

### EXAMPLES

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of aspects of the present disclosure.

### Example 1

Materials and Methods

Animals and Treatments.

A total of 2,400 one-day old chicks (Arbor Acres) were randomly divided into three treatment groups (800 chicks per treatment group): (1) Control (did not receive nutrient and/or spore treatment); (2) received spore treatment only; (2) received nutrient and spore treatment. The 800 chicks per treatment group were divided into 4 pens with 200 chicks per pen. Thus, each treatment group had 4 pens with 200 chicks each. The chicks were housed with a water-pad cooling system. The chicks were fed ad libitum during the study. The composition and nutrient levels of the starter and grower diets used in this study are listed in Table 1. No antibiotics were administered during this study. The diets and treatments were continued for 35 days.

TABLE 1
Composition of Diets for Example 1

| | | | Amount | |
|---|---|---|---|---|
| | Amount | | in Grower | |
| | in Starter Diet (fed | | diet (fed from | |
| | from day 0 to | | day 22 to 35) | |
| Ingredient | day 21) (wt %) | | (wt %) | |
| Yellow Corn, Crude Protein (CP) | 42.00 | | 50.40 | |
| 7.5% | | | | |
| Soybean Meal, CP 43.5% | 42.00 | | 36.60 | |
| Fish meal, CP 60% | 2 | | NA | |
| Soybean Oil | 10.4 | | 9.0 | |
| Limestone, pulverized | 1.9 | | 2.0 | |
| Dicalcium phosphate | 0.6 | | 1.0 | |
| Choline chloride (50% in a mixture | 0.1 | | 0.1 | |
| with 50% silica carrier) | | | | |
| Salt | 0.4 | | 0.4 | |
| Vitamin premix | 0.2 | | 0.2 | |
| Mineral premix | 0.2 | | 0.2 | |
| DL-methionine, 99% pure | 0.2 | | 0.2 | |
| TOTAL | 100 | wt % | 100 | wt % |

| | | |
|---|---|---|
| Calculated value | | |
| Metabolizable energy, kcal/kg | 3,206 | 3,207 |
| Crude Protein % | 23.04 | 20.04 |
| Ca, % | 1.02 | 1.05 |
| Total Phosphorus, % | 0.55 | 0.56 |
| Lysine, % | 1.35 | 1.12 |
| Methionine, % | 0.58 | 0.45 |
| Threonine, % | 0.91 | 0.78 |

For treatment group 2, a spore formulation containing 10⁹ CFU/mL of a spore blend formulation was used. The spore blend contained 3 strains of Bacillus bacteria: 2 strains were each a strain of the species Bacillus licheniformis and the third strain was a species of Bacillus subtilis. About 80% of the formulation was Bacillus licheniformis (40% of each strain) spores and 20% of the spores in the spore formulation were Bacillus subtilis. The spore blend also included water, thickener, and organic salts. The spore blend formulation was added once daily to the drinking water for a final concentration in the drinking water of about 10⁷ CFU/mL (2.3×10⁷ CFU/mL for the first week of the trial and at about 1.2×10⁷ CFU/mL for weeks 2-5 of the trial). For treatment group 2, the spores were not heated prior to administration.

For treatment group 3, a heated nutrient-spore formulation was added once daily to the drinking water. To generate the heated nutrient-spore formulation, a starting nutrient formulation was mixed with a starting spore formulation to form a working nutrient-spore formulation (see Table 3). 1 L of the working nutrient-spore formulation was heated for about 1 hour at about 42° C. After heating, the nutrient-spore formulation was added to the drinking water to generate a final nutrient-spore formulation. The concentration of the starting nutrient formulation used to generate the working nutrient-spore formulation was considered to be at 100% concentration for purposes of subsequent dilution calculations. The contents in the starting nutrient formulation are listed in Table 2.

TABLE 2
Components of a Nutrient Formulation.

| | wt % in | | | |
|---|---|---|---|---|
| | Starting | g/L in Starting | g/L in Working | g/L in |
| | Nutrient | Nutrient | Nutrient-Spore | Final dose |
| Component | Formulation | Formulation | Formulation | (mL/bird) |
| Water | 82.9 | 829 | 996.58 | 999.97 |
| L-alanine | 8.9 | 89 | 1.78 | 0.0178 |
| Disodium | 6 | 60 | 1.2 | 0.012 |
| phosphate | | | | |
| monosodium | 2 | 20 | 0.4 | 0.004 |
| phosphate | | | | |
| Germaben II | 0.2 | 2 | 0.04 | 0.0004 |

The starting spore formulation (e.g. the spore blend described above) contained about 10¹⁰ CFU/mL spores. The working nutrient-spore formulation contained about 10⁹ CFU/mL spores suspended in about a 2% (v/v) starting nutrient solution. The specific composition of the working nutrient-spore formulation is shown in Table 3.

TABLE 3
Working Nutrient-Spore Formulation.

| | | | Final |
|---|---|---|---|
| | | | Concentration in |
| | | Starting | Working Nutrient- |
| Component | Volume | Concentration | Spore Formulation |
| Starting Nutrient | 20 mL | 100% (v/v) | 2% (v/v) |
| Formulation | | | |
| Starting Spore | 100 mL | about 10¹⁰ CFU/mL | about 10⁹ CFU/mL |
| Formulation | | | |
| Water | 880 mL | 100% (v/v) | 88% (v/v) |
| Final Volume | 1000 mL | NA | NA |

After heating, the working nutrient-spore formulation was added to drinking water such that the final concentration of the spores was about 10⁷ CFU/mL (2.3×10⁷ CFU/mL for the first week of the trial and at about 1.2×10⁷ CFU/mL for weeks 2-5 of the trial) and the final concentration in nutrient formulation was about 0.02% (v/v) in the drinking water. This corresponded to about a 100 fold dilution of the working nutrient-spore formulation.

Temperature Monitoring of the Chicken House.

The temperature of the chicken house was monitored every day at 07:00, 12:00, 18:00, and 22:00.

Measurements.

Body weight (group weighing, 50 chicks marked/pen) was determined at the beginning and every 7 days during the trial. Feed consumption of each pen was recorded to determine daily gain, daily feed intake, and feed conversion rate. The mortality was monitored every week.

Water consumption of the chicks (mL/bird/day) was determined every week by measuring the volume of water consumed by each treatment group from the individual water tank supplying each treatment group.

Fecal odor levels were determined from collecting 30 samples/pen at the end of the starter (day 21) and grower phase (day 35). Fecal samples were incubated at room temperature in a paper box for about 6 hours, and then NH₃ and H₂S levels were measured with GASTEC gas detection tubes (Gastec Model GV-100 Gas Sampling Pump, Gastec, Japan).

Contents of small and larger intestines from 5 chicks/pen were collected as a pooled sample for determination of total colony forming units (cfu) for Lactobacillus, E. coli., and Salmonella.

Results.

Temperature of the Chicken House.

The measured temperature of the chicken house is shown in Table 4. The target temperature for the chicks during the first week was 30° C. and then was 2° C. lower for each subsequent week until week 4-5, where it remained constant as shown in Table 4. The average temperature of the chicken house in the first week of the trial was about 30.1° C., which was close to the target temperature. After week 2, the average and all four monitored temperatures were greater than the target temperature for the rest of the trial period (weeks 2-5). The temperature remained about 28-30° C. during week 2-5, indicating that there may have been heat stress as the chickens grew heavier.

TABLE 4
Measured Temperature of Chicken House (° C.)

| | | Average | Average | Average | Average | Average |
|---|---|---|---|---|---|---|
| | Target | Measured | 07:00 | 12:00 | 18:00 | 22:00 |
| Week | Temp. | Temp. | Temp. | Temp. | Temp. | Temp. |
| 1 | 30 | 30.1 | 30.3 | 30.7 | 30.1 | 29.1 |
| 2 | 28 | 29.3 | 28.8 | 29.3 | 30.1 | 29.1 |
| 3 | 26 | 29.2 | 28.9 | 29.3 | 29.8 | 28.8 |
| 4 | 24 | 28.5 | 28.3 | 28.7 | 29.0 | 28.0 |
| 5 | 24 | 28.7 | 28.8 | 29.2 | 28.8 | 27.8 |

Water Intake.

The amount of water consumption increased as the chicks grew heavier (see Table 5.) There was no observed difference in water consumption between the control and treatment group 2 during the trial with the exception of week 2, in which the Treatment Group 2 chicks consumed about 13% less water. As compared with the control, the Treatment Group 3 chicks had about a 7 to about 20% lower water intake from week 2 to week 5. Water intake of the Treatment Group 3 group chicks was also lower than the Treatment Group 2 chicks by about 9% to about 18%. The decreased water intake was observed to be specific to the treatment group.

TABLE 5
Effect of Treatment On Water Consumption (mL/bird/day)

| | | | Treatment Group 3 |
|---|---|---|---|
| | Treatment Group 1 | Treatment Group 2 | (Nutrient-Spore |
| Week | (control) | (Spores Only) | Formulation) |
| 1 | 45.0 | 49.5 | 49.6 |
| 2 | 106.1 | 108.7 | 98.7 |
| 3 | 215.3 | 186.9 | 170.6 |
| 4 | 263.7 | 271.8 | 243.2 |
| 5 | 470.0 | 460.6 | 377.1 |

Growth Performance and Mortality.

The Treatment Group 2 and Treatment Group 3 chicks were observed to have greater body weight throughout the trial (see e.g. Table 6). Different letters indicate significant differences between groups. At day 21, body weight of Treatment Group 2 chicks was about 4.4% (P>0.05) heavier than the Treatment Group 1 (control) chicks, and the Treatment Group 3 chicks were 8.4% (P<0.05) heavier than the Treatment Group 1 (control) chicks. At day 35, both Treatment Groups 2 and 3 chicks were heavier (P<0.01) than the control resulting in about 105 g and about 160 g/bird more weight, respectively.

Treatment Groups 2 and 3 chicks were observed to have better weight gain and feed conversion rates. In the starter phase of the trial Treatment Groups 2 and 3 had about 4.5% (P>0.05) and 8.6% (P<0.05) greater gain than Treatment Group 1 (control) chicks, respectively. In the grower phase of the trial, Treatment Groups 2 and 3 chicks had a numerically greater gain (about 6.1% and 7.3%, respectively) than Treatment Group 1 (control) chicks. FCR was greater in Treatment Group 2 (about 4.7%, P<0.05) and Treatment Group 3 (about 10.3%, P<0.01) chicks during the starter phase. Treatment Group 3 chicks continued to have a numerically improved FCR during the grower phase, which was about 11.7% less than Treatment Group 1 (control) and about 8.2% less than Treatment group 2 chicks. The Treatments were not observed to have an effect on feed intake. Overall, both the Treatment 2 and Treatment 3 were observed to improve growth performance, with Treatment 3 being more effective than Treatment 2.

No significant difference in mortality among the treatment groups was observed. The accumulated mortality was about 7.75%, 7.50%, and 7.13% for Treatment Groups 1, 2, and 3, respectively.

TABLE 6
Effects of Treatment Group on Growth
performance of Chicks (1-35 days)

| | Treatment | Treatment | Treatment Group | |
|---|---|---|---|---|
| | Group | Group 2 | 3 (Nutrient- | P |
| Item | 1 (control) | (Spores only) | Spore) | value |
| Body weight | | | | |
| (g/chick) | | | | |
| Day 0 | 35.1 | 35.3 | 35.8 | >0.05 |
| Day 21 | 1114.0^{b} | 1162.9^{ab} | 1207.7^{a} | <0.05 |
| Day 35 | 2031.1^{b} | 2136.2^{a} | 2191.4^{a} | <0.01 |
| Day 0 to 21 | | | | |
| (starter phase), | | | | |
| g/pen | | | | |
| Feed Intake | 1353.0 | 1349.6 | 1325.5 | >0.05 |
| Gain | 1078.9^{b} | 1127.5^{ab} | 1171.9^{a} | <0.05 |
| Feed Conversion | 1.26^{c} | 1.20^{b} | 1.13^{c} | <0.01 |
| Rate (FCR) | | | | |
| Day 22 to 35 | | | | |
| (Grower phase), | | | | |
| g/pen | | | | |
| Feed Intake | 1805.6 | 1860.0 | 1709.1 | >0.05 |
| Gain | 917.1 | 973.3 | 983.7 | >0.05 |
| Feed Conversion | 1.97 | 1.92 | 1.74 | >0.05 |
| Ratio (FCR) | | | | |
| Day 0 to 35, | | | | |
| g/pen | | | | |
| Feed Intake | 3158.6 | 3209.6 | 3034.6 | >0.05 |
| Gain | 1996.0^{b} | 2100.8^{a} | 2155.6^{a} | <0.01 |
| Feed Conversion | 1.58^{b} | 1.53^{ab} | 1.41^{a} | <0.05 |
| Ratio (FCR) | | | | |

Fecal Odors and Microbes.

As compared with the Treatment Group 1 (control) NH₃ levels at day 21, the fecal NH₃ levels were inhibited (about 64-74%) in Treatment Groups 2 and 3. (P<0.01, Table 7). Fecal NH₃ levels were numerically lower in Treatment Groups 2 and 3 at day 35 (about 42% and about 40% lower, respectively).

Fecal H₂S levels were about 16% in Treatment Group 2 and about 43% lower in Treatment Group 3 at day 21, which was numerically lower than control. At day 35, a similar trend was observed on fecal H₂S levels. Treatment Groups 2 and 3 had numerically lower H₂S levels (about 27% and about 42% lower, respectively).

Both Treatment Groups 2 and 3 had significantly different microbe counts in the small and large intestines (see e.g. Table 8). Lactobacillus was increased (P<0.05), and E. coli and Salmonella were decreased (P<0.01) in both Treatment Groups 2 and 3 at days 21 and 35.

TABLE 7
Effects of Treatment 2 and Treatment 3 addition
to drinking water on fecal odor levels.

| | | Treatment | | | |
|---|---|---|---|---|---|
| | | Group 1 | Treatment | Treatment | |
| Item | n | (control) | Group 2 | Group 3 | P value |
| Day 21 | | | | | |
| NH₃ (ppm/ | 4 | 5.09 | 1.32 | 1.80 | <0.01 |
| 100 g feces) | | | | | |
| H₂S (ppm/100 g | 4 | 93.2 | 78.3 | 53.2 | >0.05 |
| feces) | | | | | |
| Day 35 | | | | | |
| NH₃ (ppm/ | 4 | 7.39 | 4.31 | 4.44 | >0.05 |
| 100 g feces) | | | | | |
| H₂S (ppm/100 g | 4 | 77.8 | 56.7 | 44.7 | >0.05 |
| feces) | | | | | |

TABLE 8
Effect of Treatment addition to drinking water
on intestinal microbes of chicks.

| | | Treatment | | | |
|---|---|---|---|---|---|
| | | Group 1 | Treatment | Treatment | |
| Item | n | (control) | Group 2 | Group 3 | P value |
| Day 21 | | | | | |
| Small | | | | | |
| Intestine | | | | | |
| Lactobacillus | 4 | 0.02 | 12.48 | 10.13 | <0.05 |
| (log⁸) | | | | | |
| E. Coli (log⁸) | 4 | 11.0 | 0.07 | 0.19 | <0.01 |
| Salmonella | 4 | 0.95 | 0 | 0 | <0.01 |
| (log⁵) | | | | | |
| Large | | | | | |
| Intestine | | | | | |
| Lactobacillus | 4 | 0.01 | 6.90 | 9.11 | <0.05 |
| (log⁸) | | | | | |
| E. Coli (log⁸) | 4 | 28.75 | 0.14 | 0.33 | <0.001 |
| Salmonella | 4 | 0.93 | 0 | 0 | <0.01 |
| (log⁵) | | | | | |
| Day 35 | | | | | |
| Small | | | | | |
| Intestine | | | | | |
| Lactobacillus | 4 | 0.01 | 0.07 | 7.18 | <0.05 |
| (log⁸) | | | | | |
| E. Coli (log⁸) | 4 | 19.25 | 0.04 | 0.01 | <0.05 |
| Salmonella | 4 | 2.55 | 0 | 0 | <0.05 |
| (log⁵) | | | | | |
| Large | | | | | |
| Intestine | | | | | |
| Lactobacillus | 4 | 0.61 | 14.75 | 60.00 | <0.05 |
| (log⁸) | | | | | |
| E. Coli (log⁸) | 4 | 22.50 | 0.28 | 0.23 | <0.05 |
| Salmonella | 4 | 25.0 | 0 | 0 | <0.05 |
| (log⁵) | | | | | |

### Example 2

### Materials and Methods

Three aquariums were used for this study. Each held 55 gallons of water and 25 Malaysian prawns to mimic stocking densities of commercial shrimp farms. Each aquarium contained the same type of netting and substrate composed of polyvinyl chloride (PVC) pipe provided for shrimp habitation and resting. All aquariums were lined with Caribbean live sand to discourage algal growth, reduce nitrates, help buffer the aquarium system, and ensure safer aquarium cycling. Aeration stones were used in all three aquariums to improve biological filtration and increase dissolved oxygen content for shrimp and beneficial bacteria. All three aquariums used the same type of filter and filters were rinsed off, as needed, and reused. All three aquariums were refilled with deionized (DI) water as needed. DI water was used to control mineral content of the water.

When large amounts of water needed to be removed from an aquarium, the same amount of water was removed from all aquariums and replaced with the same amount of DI water. Calcium carbonate was used in aquariums 2 and 3 for water replacements to mimic the use of a Pond Powder. When water was replaced in aquariums 2 or 3, about 0.5 g of calcium carbonate was added to tank water. About 1 mL of an incubated working nutrient-spore solution was applied once daily Monday-Friday to aquarium 3. Aquarium 1 was the control aquarium. Briefly, 20 μL of a starting spore solution (contained about 10¹⁰ CFU/mL) was mixed with 20 μL of a starting nutrient solution and 960 μL of water to form a working nutrient-spore solution that contained about 2×10⁸ CFU/mL spores (Table 10). The starting spore solution was a spore blend containing about 10¹⁰ CFU/mL spores. The spore blend contained 3 strains of Bacillus bacteria: 2 strains were each a strain of the species Bacillus licheniformis and the third strain was a species of Bacillus subtilis. About 80% of the formulation was Bacillus licheniformis (40% of each strain) spores and 20% of the spores in the spore formulation were Bacillus subtilis. The spore blend also included water, thickener, and organic salts.

The nutrient-spore formulation was incubated at about 42° C. for about 1 hour. Following this incubation, the entire working nutrient-formulation (about 1 mL) was added to aquarium 3. Mixing was accomplished via aeration by mixing stone. Table 9 shows the composition of the starting nutrient formulation. Table 10 shows the composition of the working nutrient-spore formulation. After mixing the incubated working nutrient-spore formulation into 55 gallons of aquarium 3, the concentration of the spores was about 9.6×10² CFU/mL and the final percent of the nutrient formulation was about 9.6×10⁻⁶% v/v. The contents of each aquarium after their respective treatments have been applied are shown in Table 11. The trial continued for 120 days.

TABLE 9
Components of a Nutrient Formulation.

| | wt % in | g/L in | | |
|---|---|---|---|---|
| | Starting | Starting | g/L in Working | |
| | Nutrient | Nutrient | Nutrient-Spore | g/L in Final |
| Component | Formulation | Formulation | Formulation | Dilution |
| Water | 82.9 | 829 | 996.58 | 999.97 |
| L-alanine | 8.9 | 89 | 1.78 | 8.5 × 10⁻⁶ |
| Disodium | 6 | 60 | 1.2 | 5.76 × 10⁻⁶ |
| phosphate | | | | |
| monosodium | 2 | 20 | 0.4 | 1.92 × 10⁻⁶ |
| phosphate | | | | |
| Germaben II | 0.2 | 2 | 0.04 | 1.92 × 10⁻⁷ |

TABLE 10
Working Nutrient-Spore Formulation.

| | | Starting | |
|---|---|---|---|
| Component | Volume | Concentration | Final Concentration |
| Starting Nutrient | 20 μL | 100% (v/v) | 2% (v/v) |
| Formulation | | | |
| Starting Spore | 20 μL | about 10¹⁰ CFU/mL | about |
| Formulation | | | 2 × 10⁸ CFU/mL |
| Water | 960 μL | 100% (v/v) | 96% (v/v) |
| Final Volume | 1000 μL | NA | NA |

TABLE 11
Aquarium Contents (Treatment Groups)

| Aquarium 1 | Aquarium 2 | Aquarium 3 (Nutrient-Spore |
|---|---|---|
| (Control | (Pond Powder Only | Formulation and Pond Powder |
| Treatment Group) | Treatment Group) | Treatment Group) |
| No additions | 0.5 g of Calcium | 1 mL of incubated Working- |
| | Carbonate added | Nutrient Spore Formulation |
| | per every water | and 0.5 g of Calcium |
| | replacement | Carbonate added per every |
| | | water replacement |

Results

Table 12 shows the final weight and body measurements of the averaged trial groups as well as standard deviations. The control group in aquarium 1 had the smallest shrimp weight and body measurements compared to treatment groups in aquariums 2 and 3. Aquarium 3 had the largest shrimp and had the best results in terms of shrimp size compared to the prawns in aquariums 2 and 1. The average final weight of shrimp in aquarium 3 was 6.48 g. The average final weight of the prawns in aquarium 2 was 4.87 g on average. The average final weight of the prawns in aquarium 1 (the control) was 3.43 g. The average total length for prawns in aquarium 3 was also the greatest at 7.98 cm. The average total length for prawns in aquarium 2 was 7.41. The average total length for prawns in aquarium 1 (the control group) was 6.95. The average tail length of prawns in aquarium 3 was 4.67 cm. The average tail length of prawns in aquarium 2 was 4.26 cm. The average tail length of prawns in aquarium 1 (control) was the smallest at 3.87 cm.

TABLE 12
Effect of Treatment on Growth Performance.

| | | Calcium | Spores + Calcium |
|---|---|---|---|
| | Control | Carbonate | Carbonate |
| Average Final Weight (g) | 3.43 | 4.87 | 6.48 |
| Average Total Length (cm) | 6.95 | 7.41 | 7.98 |
| Average Tail Length (cm) | 3.87 | 4.26 | 4.67 |
| Standard Deviation | 0.77 | 4.11 | 4.76 |
| Average Final Weight | | | |
| Standard Deviation | 0.42 | 1.49 | 1.30 |
| Average Total length | | | |
| Standard Deviation | 0.27 | 0.68 | 0.81 |
| Average Tail Length | | | |

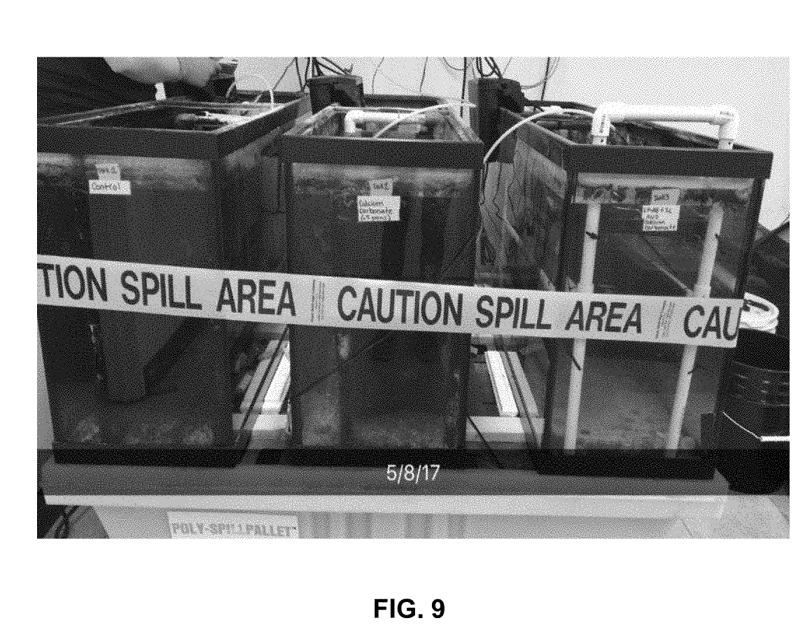

FIG. 9 shows an image of the three aquariums that can demonstrate the water clarity in each group by the end of the 120 day trial. In terms of water clarity, aquarium 3 was observed to be clearest. Aquarium 1, the control, was observed to have the greatest amount of algal growth covering the aquarium walls as compared to aquariums 2 and 3. Aquarium 2 was observed to have only moderate algal growth on the aquarium walls as compared to the control and aquarium 3.

During the 120-day trial, all three aquariums started off with little to no algae on the sides of the aquariums. As the trial progressed, the control aquarium (aquarium 1) accumulated more algal growth on the sides of the aquarium (see e.g. FIG. 9). Aquarium 2 had less algal growth than aquarium 1. Aquarium 3 had little to no algal growth as compared to aquariums 1 and 2.

Water parameters were consistent throughout the trial. Ammonia levels were zero for all three aquariums. Nitrite/nitrate were also within safe ranges for the duration of the trial. pH also stayed within normal ranges of about 7.5 to 8.5 for all of the aquariums. There were no water parameter spikes observed that could have harmed the prawns as aquarium cycling occurred safely and parameters remained consistent for the full length of the 120-day trial.

### Example 3

Materials and Methods.

Plant Propagation and Conditions.

Soil was autoclaved before use to remove exogenous bacteria. Seeds were germinated in an incubated growing chamber for about four days until sprouting. Once sprouted, each seedling was transferred into its final growing pot. Final growing pots were placed in an enclosed plant set-up containing fluorescent growth lights and warming mats to mimic the warmth and humidity of a greenhouse. Initially, plants were being watered automatically with a self-watering system; however, as the trial progressed it was determined that some of the plants were receiving more water than other groups. The self-watering spouts also dripped in the same spot in potted plants, not soaking the entire root system which led to wilting across plant groups. On about day 17 of trial, watering was switched from automatic system to manual waterings by pipet for the duration of study. As plants matured, they received weekly trimmings including trimming dead leaves and trimming the tops of plants when they began to touch growth lights.

Treatments.

The plants were divided into four treatment groups. Treatment group 1 was a control group that did not receive treatment with a nutrient-spore formulation. The other three treatment groups received varying amounts of an incubated nutrient-spore formulation. Briefly, a starting spore formulation (a spore blend) was mixed with an amount of a starting nutrient formulation to form a working nutrient-spore formulation. The starting spore formulation contained 3 strains of Bacillus bacteria: 2 strains were each a strain of the species Bacillus licheniformis and the third strain was a species of Bacillus subtilis. About 80% of the formulation was Bacillus licheniformis (40% of each strain) spores and 20% of the spores in the spore formulation were Bacillus subtilis. The spore blend also included water, thickener, and organic salts. The formulation of the working nutrient-spore formulations are shown in Table 13.

TABLE 13
Treatment Group Formulations.

| | | | | (Concentration of |
|---|---|---|---|---|
| | | μL Starting | | Spores) and (% Nutrient |
| | μL Starting | Nutrient | | Formulation) in Working |
| | Spore | Formulation | | Nutrient-Spore |
| Treatment Group | Formulation (10¹⁰ CFU/mL) | (100%) | μL Water | Formulation |
| 1. Control | 0 | 0 | 1000 | 0 |
| 2. High | 25 | 40 | 935 | (2.5 × 10⁸ CFU/mL) (4%) |
| 3. Medium | 12.5 | 40 | 947.5 | (1.25 × 10⁸ CFU/mL) (4%) |
| 4. Low | 5 | 40 | 955 | (5 × 10⁷ CFU/mL) (4%) |
| Final Volume | | | 1000 | |

The entire volume (about 1 mL) of the working nutrient-spore formulations were then incubated at about 42° C. for about 1 hour. After incubation, about 1 mL of the working nutrient-spore formulations or water were each added to 49 mL of deionized (DI) water, which was used to directly dose the plants. The final dose of each formulation is shown in Table 14. About 10 mL the incubated working nutrient-spore formulation was delivered directly to each of the plant's with a pipette. In addition to the 10 mL of treatment or control given to each of the plants, each plant received about 60 mL of DI water a day from an automatic watering system. On about day 17 of the trial, it was observed that the automatic watering system was not resulting in even water distribution. From that point on and for the duration of the study, the plants were manually watered the same amount, when needed. Administration was done once daily for a total of 5 days per week. The trial continued for 65 days.

TABLE 14
Administered Dose Formulations.

| | mL Working | | (Concentration |
|---|---|---|---|
| | Nutrient Spore | | of Spores) and (% |
| Treatment | Formulation | mL | Nutrient Formulation) in |
| Group | or water | Water | Final Dose Administered |
| 1. Control | 1 mL water | 49 | 0 |
| 2. High | 1 mL | 49 | (5 × 10⁶ CFU/mL) (0.08%) |
| 3. Medium | 1 mL | 49 | (2.5 × 10⁶ CFU/mL) (0.08%) |
| 4. Low | 1 mL | 49 | (1 × 10⁶ CFU/mL) (0.08%) |
| Final | | 50 | |
| Volume | | | |
| (mL) | | | |

### Measurements.

True leaf growth and true leaf diameter were measured until plants began needing weekly trimmings. Once plants were trimmed, the number of true leaves could not be accurately recorded. Measurements of each plant were taken including: width (from the widest points of the plant-leaf tip to leaf tip), height, and number of branches extending from the main stem. Any other observations such as number of leaves trimmed or other noticeable growth in plants were also documented on the day it was observed.

Plants had ad hoc trimmings of leaves that were yellowing or that had brown spots. Plants were also trimmed back when they began to touch the light fixture of the plant setup. Because plants had to be cut back in height to remain in the lab setup, final heights were not used as growth indicators in this study. Growth indicators that were used consisted of the diameter of widest point on the plant, root width, root weight, and number of branches extending from the main stem of the plant. These parameters of growth were selected because they best compared the robustness of plant growth between the plant groups. Root growth was examined by gently removing dirt from root system manually and then rinsing roots with water.

Results

Table 15 shows the average values of final measurements documented at the end of the trial, with the greatest values in each category underlined. Treatment group 4 had the most branches from the main stem (11.4), the largest root width (8.4 cm), and the largest root weight (64.84 g). Treatment group 3 also had a large root width (8.3 cm) and the largest total plant diameter (27.6 cm).

| | Final | # Branches | Length of | Width of | |
|---|---|---|---|---|---|
| Treatment | Widths | off Main | Roots | Roots | Weight of |
| Group | (cm) | Stem | (cm) | (cm) | Roots (g) |
| 4. High | 26.9 | 11.4 | 20.4 | 8.4 | 64.84 |
| 3. Medium | 27.6 | 7.8 | 18.6 | 8.3 | 22.28 |
| 2. Low | 23.5 | 7.4 | 17.8 | 6.8 | 25.48 |
| 1. Control | 25.2 | 9.6 | 23.3 | 6.3 | 15 |

1. A method of enhancing the performance of an animal, the method comprising:
administering a nutrient-spore formulation to the animal, wherein the nutrient-spore formulation comprises an effective amount of spores and wherein at least one of the spores is activated.

2. The method of claim 1, wherein the nutrient-spore formulation comprises an effective amount of a nutrient formulation.

3. The method of claim 1, wherein the animal is a chicken.

4. The method of any one of claim 3, wherein the effective amount of spores ranges from about 5×10² to about 5×10⁷ CFU/m L.

5. The method of claim 3, wherein the effective amount of the nutrient formulation ranges from about 2% (v/v) to about 4% (v/v) prior to a final dilution in a water source.

6. The method of claim 2, wherein the animal is a shellfish.

7. The method of claim 6, wherein the shellfish is a shrimp or a prawn.

8. The method of claim 6, wherein the effective amount of spores ranges from about 1×10² to about 1×10³ CFU/mL.

9. The method of claim 6, wherein the effective amount of spores is about 9.6×10² CFU/mL.

10. The method of claim 6, wherein the effective amount of the nutrient formulation ranges from about 2% (v/v) to about 4% (v/v) prior to any dilution in a water source.

11. The method of claim 6, wherein the effective amount of the nutrient formulation is about 9.6×10⁻⁶% (v/v).

12. The method of claim 1, wherein the nutrient-spore formulation is administered to the animal via a source of drinking water.

13. The method of claim 1, wherein about 50% to about 100% of the spores in the effective amount of spores are activated.

14. A method of enhancing the performance of a plant, the method comprising:
administering a nutrient-spore formulation to the plant, wherein the nutrient-spore formulation comprises an effective amount of spores, wherein at least one of the spores is activated.

15. The method of claim 14, wherein the effective amount of spores ranges from about 1×10⁵ CFU/mL to about 5×10⁷ CFU/mL.

16. The method of claim 14, wherein the effective amount of spores is about 5×10⁶ CFU/mL.

17. The method of claim 14, wherein the nutrient-spore formulation further comprises an effective amount of a nutrient formulation.

18. The method of claim 17, wherein the effective amount of the nutrient formulation ranges from about 2% (v/v) to about 4% (v/v) prior to a dilution into a water source.

19. A method comprising:
mixing an amount of a nutrient formulation with an amount of a spore formulation to form a nutrient-spore formulation,
wherein the spore formulation comprises spores, and
wherein the nutrient formulation comprises an L-amino acid, a buffer, and a preservative; and
heating the nutrient-spore formulation to form an activated nutrient-spore formulation, wherein about 50% to about 100% of the spores are activated,
wherein the steps of mixing and heating are performed at the point of use.

20. The method of claim 19, wherein the preservative is a germination inhibitor.

21. The method of claim 19, wherein the steps of mixing and heating are performed within 1 second to 5 minutes of each other.

22. The method of claim 19, wherein the method further comprises the step of diluting the activated nutrient-spore formulation to form a diluted-activated nutrient-spore formulation.

23. The method of claim 22, further comprising the step of administering the diluted-activated nutrient spore formulation to an animal or a plant.

24. The method of claim 22, wherein the diluted-activated nutrient-spore formulation comprises an effective amount of spores.

25. The method of claim 24, wherein the effective amount of spores ranges from about 1×10² to about 5×10⁷ CFU/mL.

26. The method of claim 24, wherein the effective amount of spores ranges from about 1×10² to about 1×10³ CFU/mL.

27. The method of claim 24, wherein the effective amount of spores ranges from about 1×10⁶ CFU/mL to about 5×10⁶ CFU/mL.

28. The method of claim 21, further comprising the step of administering the activated nutrient-spore formulation to a plant or animal.

29. The method of claim 28, wherein the activated nutrient-spore formulation comprises an effective amount of spores.

30. The method of claim 28, wherein the effective amount of spores ranges from about 1×10² to about 5×10⁷ CFU/mL.

31. The method of claim 28, wherein the effective amount of spores ranges from about 1×10² to about 1×10³ CFU/mL.

32. The method of claim 28, wherein the effective amount of spores ranges from about 1×10⁶ CFU/mL to about 5×10⁶ CFU/mL.

33. The method of claim 19, wherein the activated nutrient-spore formulation or the diluted-activated nutrient-spore formulation is administered to the animals via drinking water or the plants via irrigation water.

34. The method of any claim 19, wherein the nutrient-spore formulation is heated to about 42° C. during the step of heating.

35. The method of claim 19, wherein the step of heating occurs for about 2 to about 60 minutes.

36. A nutrient-spore formulation comprising:
an effective amount of spores;
an effective amount of a nutrient formulation; and
a diluent.

37. The nutrient-spore formulation of claim 36, wherein the effective amount of spores is about 1×10⁷ CFU/mL to about 1×10⁹ CFU/mL.

38. The nutrient-spore formulation of claim 36, wherein the effective amount of the nutrient formulation ranges from about 2% (v/v) to about 4% (v/v).

39. The nutrient-spore formulation of claim 36, wherein the diluent is water.

40. The nutrient-spore formulation of claim 36, wherein about 50% to about 100% of the spores are activated.

41. A formulation comprising:
an effective amount of spores, wherein about 50% to about 100% of the spores are activated and wherein the effective amount of spores ranges from about 1×10² CFU/mL to about 1×10⁷ CFU/mL;
a nutrient formulation, wherein the nutrient formulation comprises an L-amino acid, a buffer, a preservative, and a source of potassium ions; and
a diluent.

42. The formulation of claim 41, wherein the nutrient formulation further comprises a sugar.

43. The formulation of claim 41, wherein the effective amount of spores ranges from about 1×10² to about 5×10⁷ CFU/mL.

44. The formulation of claim 43, wherein the effective amount of spores is sufficient to improve a performance characteristic of a chicken.

45. The formulation of claim 41, wherein the effective amount of spores is about 9.6×10².

46. The formulation of claim 45, wherein the effective amount of spores is sufficient to improve a performance characteristic of a shrimp or a prawn.

47. The formulation of claim 41, wherein the effective amount of spores ranges from about 1×10⁶ CFU/mL to about 5×10⁶ CFU/mL.

48. The formulation of claim 41, wherein the effective amount of spores is about 5×10⁶ CFU/mL.

49. The formulation of claim 47, wherein the effective amount of spores is sufficient to improve a performance characteristic of a plant.
